(19) United States
(12) Patent Application Publication
(10) Pub. No.: US 2025/0245817 A1
(43) Pub. Date: Jul. 31, 2025

(54) IMAGE PROCESSING DEVICE FOR SUPPORTING A QUALITATIVE AND/OR QUANTITATIVE EVALUATION OF THE QUALITY OF A CRIMP CONNECTION, IMAGE EVALUATION DEVICE, AND MANUFACTURING RELEASE SYSTEM FOR A CRIMPING DEVICE

(71) Applicant: MD Elektronik GmbH, Waldkraiburg (DE)

(72) Inventors: Josef OHNI, Kraiburg am Inn (DE); Peter HOFINGER, Vilsbiburg (DE)

(21) Appl. No.: 18/886,588

(22) Filed: Sep. 16, 2024

(30) Foreign Application Priority Data
Jan. 26, 2024 (EP) 24154145.7

(51) Int. Cl. G06T 7/00

(52) U.S. Cl. CPC G06T 7/001; G06T 2207/10056; G06T 2207/20081; G06T 2207/20084; G06T 2207/30164

(57) ABSTRACT

The disclosure relates to an image processing device for supporting a qualitative and/or quantitative evaluation of the quality of a crimp connection, an image evaluation device, and a manufacturing release system for a crimping device with an image evaluation device according to any of claims 7 to 9, with a data interface to a database in which production order-dependent target values for crimp connections are stored, with a release unit designed to provide a release or a refusal of release for manufacturing the classified crimp connection after a comparison between at least one qualitative and/or quantitative quality parameter and a corresponding target value. This solves the task of making the determination of quality parameters of crimp connections more robust and reliable and making the production of corresponding crimp connections more reliable and less labor-intensive.

### TECHNICAL FIELD

The disclosure relates to an image processing device for supporting a qualitative and/or quantitative assessment of the quality of a crimp connection. Furthermore, the disclosure relates to an image evaluation device for the qualitative and/or quantitative assessment of the quality of a crimp connection as well as a manufacturing release system for a crimping device for the production of a crimp connection.

### STATE OF THE ART

In the production of cables, it is necessary, especially before or during the execution of a production order, to ensure that a correspondingly manufactured crimp connection for a cable, for example, a data cable, is free of defects.

For this purpose, a so-called grinding image of the manufactured crimp connection is created before the start of production or during the production of a production order. For this purpose, the crimp connection is typically cut perpendicular to a longitudinal central axis, ground, and the cross-section of the cut crimp connection is examined for specific quality parameters. Therefore, the grinding image is a cross-sectional image of the crimp connection.

Grinding images help in the development of a crimp connection in defining the crimp dimensions and in verifying the crimp quality of crimp tools as part of crimping devices.

To do this, the cross-section of the crimp connection is captured typically in digital and magnified form, for example, using a microscope, to examine it for the presence of crimp defects.

It is known to use classical image evaluation algorithms to evaluate such cross-sectional images of a crimp connection to determine corresponding crimp defects or quality parameters of the crimp connection. Typically, the results of the classical image evaluation algorithms are manually checked and manually corrected in case of inaccurate results of the image evaluation software.

Alternatively, the crimp quality of crimp connections is entirely manually checked based on the captured cross-sectional images of the crimp connection.

US2021295487 A1 discloses an evaluation method for the crimp state of a crimp connection of a cable harness. An image of a part of the crimp connection of the cable harness is captured. From this, first data related to a void in the part of the crimp connection is determined. From these first data, a crimp state of the part of the crimp connection is then determined. Cross-sectional images of a crimp connection are particularly used for this purpose, see FIG. 2, FIG. 4, FIG. 6.

CN 111 665 267 A discloses a visual recognition method for the crimp quality of a contact piece, solving the problems that the crimp quality of an existing contact body and a wire cannot be visually and deeply recognized, and that crimp quality issues often remain hidden.

EP 3 109 624 A1 discloses a cable inspection system. The cable inspection system includes a mirror arrangement with an odd number of sides arranged to form a pyramid-like structure surrounding a cable segment. A camera captures a plurality of images of the cable segment reflected by the mirrors, with each image showing a different side of the cable segment.

US 2023 245299 A1 discloses a connector inspection system for a crimping machine. The connector inspection system includes an image processing device that captures a connector to be inspected and generates a digital image of the connector. The connector inspection system further includes a connector inspection module that communicates with the image processing device to receive the digital image of the connector as an input image. The connector inspection module has a reference image. The connector inspection module compares the input image with the reference image and performs semantic segmentation between the input image and the reference image to generate an output image. The output image shows differences between the input image and the reference image to identify potential defects.

EP 2 173 015 A1 discloses a method for determining the quality of a crimp connection between a conductor and a contact, in which a crimping force is initially applied to the conductor and the contact using a crimping device. From the crimp force curve resulting during crimping, a normalized force-displacement crimp force curve is derived and a compression area under a reference crimp force curve is determined. The crimp force curve and the reference crimp force curve are divided into multiple zones, with the division considering the size of the compression area. Another area under the crimp force curve is determined and used to infer the quality of the crimp connection.

U.S. Pat. No. 7,174,324 B2 discloses a system in which estimation units that have learned in advance a relationship between known connection data belonging to the connection structure and unknown connection data belonging to the connection structure for the known connection data calculate the unknown connection data for the known connection data based on the learning result according to an input of the known connection data.

“Deep learning-based automated optical inspection system for crimp connections” by Giang Nguyen Huong et al. (XP033892793) discloses a computer vision system for automating the final inspection of crimp connections. The image processing chain and the deep learning-based model for analyzing image data of crimp connections are described concerning various defect classes.

Regarding the required documentation of corresponding results of the crimp connection inspection as part of quality assurance, this is usually created manually and occasionally even handwritten and stored in a designated database and archived.

The previous approach to determining the quality of crimp connections is costly because it is labor-intensive and often leads to non-reproducible results due to the manual and individual handling of the test personnel when determining the quality parameters, especially quantitative quality parameters of the crimp connection.

The manual documentation of the evaluation of grinding images further complicates the traceability and retrievability of already archived results of the grinding image evaluation, as these are usually not machine-readable and thus not searchable.

### DESCRIPTION

The object of the disclosure is to provide a solution by which the determination of quality parameters of crimp connections can be made more robust and reliable, and by which the production of corresponding crimp connections can be made more reliable and less labor-intensive.

The object is achieved by the subjects of the independent claims. Further developments of the disclosure are specified in the dependent claims, the description, and the accompanying figures. In particular, the independent claims of one category may also be further developed analogously to the dependent claims of another category. Further embodiments and developments result from the dependent claims and the description with reference to the figures.

The disclosure particularly includes an image processing device for supporting a qualitative and/or quantitative assessment of the quality of a crimp connection with a receiving unit for receiving a cross-sectional representation of an image, particularly designed as a digital microscope image in the visible spectral range of a crimp connection, with a processing unit that is designed to generate a raster image of the received image from the received image using a deep neural network, whereby at least the pixels of a relevant image area of the received image are assignable to a predetermined class using the trained deep neural network, particularly every pixel of the received image is assignable to a predetermined class. Furthermore, the processing unit is designed to generate at least one vector contour from the generated raster image and to generate and output an output signal based on the determined vector contour, from which at least one qualitative and/or quantitative quality parameter assignable to the crimp connection can be determined.

Such an image processing device provides a robust and reliable means to process the cross-sectional image of the crimp connection so that a reliable, objective, reproducible evaluation of the image regarding qualitative and/or quantitative quality parameters can be carried out with high reliability.

In particular, such an image processing device makes it possible to handle defects during the image acquisition step in such a way that they do not adversely affect a subsequent image evaluation. For example, an inaccurately adjusted focus, an unfavorable lighting situation, reflections on the relevant section of the cross-sectional image, or dirt on the grinding surface, etc., can be compensated for.

In particular, these defects may include contaminations of the cross-section of the crimp connection, grind edges, or unusual burrs, which can lead to errors in the evaluation of the image with classical image evaluation algorithms.

Classical image evaluation algorithms are understood to be image evaluation methods that perform image evaluation independently of machine-learned models.

Such defects in the grinding image particularly occur in production-related environments. This leads to limitations in the automation and accuracy of determining the quality parameters of the crimp connection with classical image evaluation algorithms in production-related environments.

This disadvantage can be eliminated by a corresponding image processing device, as it is robust against corresponding disturbances in image acquisition and therefore enables reliable automation in the first place.

Such an image processing device therefore also allows a cost-effective, reliable, and standardized approach regarding the image evaluation to be carried out.

The assignment of at least the pixels of a relevant image area of the received image to a predetermined class, particularly the assignment of every pixel of the received image to a predetermined class, can also be referred to as semantic segmentation of the received image. The different classes thus form a semantically segmented raster image of the crimp connection, typically a schematic representation of the cross-section of the crimp connection.

By means of such semantic segmentation of at least the relevant image area of the cross-sectional image of the crimp connection, particularly of the entire cross-sectional image, defects present in the original image that negatively impact an evaluation using conventional evaluation algorithms can be eliminated.

The relevant image area is the image area of the cross-sectional image of the crimp connection in which the crimp connection is depicted. The surrounding area within a predetermined minimum distance around the outer boundary of the crimp connection does not necessarily need to be subjected to image processing and/or evaluation, as it is usually not relevant for the quality parameters of the crimp connection.

Preferably, the cross-sectional image is captured digitally, for example, using a CCD camera behind the eyepiece of a microscope to generate images in a visible spectral range for the human eye. It may be advantageous to enlarge the capture area of the image capture device in such a way that the cross-section of the crimp connection is completely depicted and simultaneously has a sufficiently high magnification to analyze the structure of the cross-section.

Quality parameters may include both qualitative and quantitative quality parameters. A qualitative quality parameter can be, for example, the statement of whether the crimp connection or a specific quality parameter is acceptable or not, i.e., defective or defect-free according to manufacturing specifications. Quantitative quality parameters may include quantitative characteristics that measurably characterize the crimp connection, such as crimp height, crimp width, measurable crimp width, support angle, support height, flank end distance, crimp flank end distance, burr height, burr width, bottom thickness, cavities between wires, cracks. A quality parameter of the crimp connection can be determined both qualitatively and quantitatively.

By means of a correspondingly designed image processing device, the evaluation process is supported. The evaluation process can, for example, continue to be carried out using classical image evaluation algorithms based on the processed grinding image of the crimp connection, particularly based on at least one determined vector contour.

The image processing device includes a receiving unit for receiving a cross-sectional image of the crimp connection, particularly a photographic cross-sectional image of the crimp connection in digital form. This cross-sectional image advantageously but not necessarily shows the entire cross-section of the crimp connection, particularly in the maximum size within the scope of the used image capture device. The image can be captured in such a way that an outer limit of the crimp sleeve in a radial direction is fully depicted.

The image capture device may optionally be included in the image processing device. The image capture device can be, for example, a microscope installed near production. The cross-sectional images of the crimp connection captured by the image capture device can be supplied to the receiving unit of the image processing device. The image processing device is preferably arranged in a monitoring area and connected to the image capture device so that an image captured by the image capture device can be supplied to the receiving unit.

The received cross-sectional image of the crimp connection can be further processed, particularly prepared, by means of a processing unit. The processing unit includes a trained deep neural network for this purpose, with which a semantic segmentation of the received image can be performed. That is, using this trained deep neural network, at least the pixels of the relevant image area, i.e., the area showing the cross-section of the crimp connection, particularly every pixel of the received cross-sectional image of the crimp connection, can be assigned to a class.

In particular, by means of such a semantic segmentation, the relevant image content of the cross-sectional image of the crimp connection regarding the quality parameters can be recognized. The classes to which the pixels can be assigned depend on the training data and the training of the deep neural network.

In this context, any deep neural network topologies suitable for performing semantic segmentation of an image can be used.

The thus segmented image can then be converted from a raster image into a vector contour using the processing unit designed for this purpose. A vector contour is a graphically representable structure defined by mathematical expressions of lines, curves, and shapes. Unlike a raster view, which consists of pixels and can lose quality when enlarged, vector graphics retain their clarity and quality at any size change due to the mathematical expressions that describe the relationships between various points, lines, and curves of the representable structure. This increases the accuracy for subsequent evaluation, particularly in determining at least one actual value for quantitative quality parameters.

The conversion of the raster image into a vector contour is particularly advantageous in terms of the accuracy of subsequent evaluation. This means that the subsequent evaluation is no longer bound to the number of pixels in the received image, thereby improving the accuracy regarding the determination of quality parameters, particularly quantitative quality parameters. The vector contour can, for example, be designed in a surface and/or line form.

The processing unit is designed to generate and output an output signal based on the vector contour, which enables qualitative and/or quantitative quality parameters assignable to the crimp connection to be determined. This may be the generated vector contour itself, which is then available for further image evaluation, for example, using classical image evaluation algorithms or on a manual basis. In particular, the vector contour can be output as a graphical representation.

The conversion of the resulting raster image with at least three classes into a vector contour can be performed conventionally, i.e., not using a trained deep neural network. The skilled person is familiar with appropriate procedures for this. Accordingly, an output signal can also be generated and output outside the trained deep neural network.

Alternatively, the trained deep neural network can also be designed to generate the vector contour from the raster image. Furthermore, the trained deep neural network can also be designed to generate and output the output signal.

The output signal can be designed in such a way that it can be processed by a technical device to which the output signal is supplied. In particular, the output signal can be designed in such a way that the result of the image processing can be reproduced on an image display device.

However, the output signal can also be provided in such a way that the output signal, from which at least one qualitative and/or quantitative quality parameter can be determined, can be supplied to an evaluation unit and at least one qualitative and/or quantitative quality parameter can be automatically determined by the evaluation unit.

In another embodiment, the trained deep neural network includes an image transformer network, also referred to as vision transformer or viT, and/or a convolutional network, also referred to as a convolutional neural network or CNN. These are particularly suitable deep neural networks for the intended image processing.

In particular, the trained deep neural network can be designed as an image transformer network or as a convolutional network. The use of an image transformer network is particularly advantageous as it requires significantly less training effort compared to other suitable network topologies. Image transformer networks are encoder-decoder networks suitable for classifying images.

The trained deep neural network, particularly the deep convolutional network, is trained using appropriate training datasets and designed for the semantic segmentation of a cross-sectional image of a crimp connection.

As part of such training, the trainable neural network can be presented with corresponding annotated training data that include the desired classes that the trained network should later recognize.

Such a training dataset can, for example, be manually created from historical data already available, for example, from defect-free and defective grinding images of past production orders. Such cross-sectional images of crimp connections are readily available as cable production is routinely monitored and grinding images are therefore made at certain intervals and the data is available for quality assurance reasons over a longer period.

The training of a deep neural convolutional network is described as an example below. It is understood that the described creation of the training data and the training form separate subjects.

For the training of the deep neural network, a corresponding set of training images is generated. The images include a cross-sectional image of the crimp connection and a desired class assignment of pixels.

For example, all pixels showing an inner conductor are assigned to one class, all pixels showing the crimp sleeve are assigned to another class, and all pixels that lie outside the crimp sleeve in a radial direction are assigned to an additional class.

The training data here include not only defect-free crimp connections but also defective crimp connections so that the pixels can be assigned to the classes regardless of their relative arrangement on the cross-sectional image.

The capture of corresponding images and their qualification can take place in normal production or testing operations so that a variety of images with different crimping, size, view direction, rotation, contrast, lighting, obstruction, etc., can be generated and the classes determined offline can be supplemented. This qualification of the images can be done by hand or at least partially performed or supported by a conventional image processing system, with manual rework being possible. The pre-qualified training images can then be further pre-processed for training.

For example, as part of further preprocessing, the size of the training images can be adjusted to a predetermined size. In particular, the number of pixels in the training images can be adapted to the number of inputs of an input layer of the neural network. The preprocessing of the training images can also include normalizing the images.

In one embodiment, the aforementioned preparation and preprocessing of the images are not performed so that the trained neural network can handle corresponding raw data, which increases the later speed of semantic segmentation using the trained deep neural network.

To improve and make the results of the neural network more robust, the training images can be subjected to random image manipulations. Such image manipulations can include, for example, rotating, enlarging, reducing, and/or distorting. It is understood that corresponding magnitudes for the respective image manipulation can be specified.

For example, for enlarging or reducing, a maximum enlargement or reduction in percentage can be specified, for example, 110% or 90%. For rotation, a maximum or minimum rotation angle, for example, +/−10°, 20°, or 30°, can be specified. Similarly, corresponding limits can be specified for distortion. It is understood that different algorithms for image distortion can be used, which can have different parameters.

The image manipulations serve to provide the training data with greater variability. The intended classes will then consequently be present in different places and in different sizes in the image. This prevents, for example, the neural network from learning to identify the given feature only in a small section of an image and falsely concluding that the feature is not present even though it is, for example, merely outside the section.

After preprocessing the training images, the neural network is trained with a portion of the training images obtained in this way. The remaining training images can be used to check the learning success by being supplied to the trained neural network and comparing its output with the known or expected output for the respective training image. This portion of the training images can therefore also be referred to as test data.

After completing the training, the quality of the training can be checked as described above using a qualification of the test data by the trained neural network. If the results meet the desired quality, the training can be completed. If the results do not meet the desired quality or if the neural network is to be further trained, the training can be continued with corresponding training data or conducted again with changed parameters.

It is understood that training can be performed differently depending on the type of neural network used.

Typically, the weights of the neural network are adjusted in each training run to minimize the error of the neural network's output compared to the known result from the training dataset. This is usually achieved through a so-called back-propagation, error feedback or back-propagation.

For training, an epoch number and a termination criterion can also be specified. The epoch number indicates the number of training runs. For each training run, a predetermined number of training data, for example, all training data or only a selection of the training data, can be used. The termination criterion indicates how far the result of the trainable neural network may deviate from the ideal result to consider the training as successfully completed and thus the neural network sufficiently well trained.

Deep convolutional networks, particularly deep convolutional neural networks, also referred to as dCNN, provide good to very good results, especially for classifying objects in image data. It is understood that other suitable neural networks from the field of machine learning are also possible.

Such a dCNN can have an input layer, a plurality of hidden layers, and an output layer. The hidden layers can at least partially include identical or repetitive layers.

The input layer can have an input for each pixel of the captured images. It is understood that the images can be transmitted to the input layer, for example, as an array or vector with the corresponding number of elements. Furthermore, the size of the captured images can be the same for all images. For example, cross-sectional images can be captured with 1024×1024 pixels, covering a capture area of 2 cm by 2 cm, 1 cm by 1 cm, or 2.5 cm by 2.5 cm.

The capture area can be selected depending on the crimp connection to be analyzed. The capture area is preferably chosen so that the cross-section of the crimp connection is completely captured.

It is understood that these specifications are merely examples, and other image parameters can be used.

For semantic image segmentation, there are some simple convolutional network architectures that serve as the basis for more sophisticated models or are suitable for simpler applications.

For example, a so-called Fully Convolutional Network, abbreviated FCN, can be used, developed for semantic segmentation. It consists of a series of convolutional layers that have been modified for image classification to generate pixel-accurate outputs.

Unlike classical Convolutional Neural Networks, abbreviated CNNs, which are typically used for classifying entire images, an FCN replaces the fully connected layers at the end of the network with convolutional operations to generate pixel-accurate outputs. The FCN also uses upsampling operations to scale the output to the original image size.

FCNs can be trained to integrate information from different scales to account for both contextual and detailed information for accurate segmentation. This can be achieved through various layers or modules that operate at different scales.

The output layer of an FCN generates a probability distribution for each class for each pixel in the input image. This output represents the predicted classes for each pixel, enabling pixel-accurate segmentation.

FCNs can be flexibly used and trained for various input image sizes. They are effective for semantic segmentation as they can generate precise pixel-to-pixel assignments for different classes or objects in an image.

In embodiments, an image transformer network can be used to perform semantic segmentation of the cross-sectional image of the crimp connection.

In the context of this application, image transformer networks are understood to be neural networks based on the transformer architecture, i.e., comprising an encoder, a decoder, or both. These are often referred to as Vision Transformers (ViT). These are transformer networks specifically developed for processing images.

An image transformer network, for example, includes the following components. First, the network can include a unit for patch processing, particularly a unit for patch embedding. A patch is understood to be a part of the image to be processed. The patch processing unit divides the received image into patches, i.e., sub-images or part images, and considers each patch as a token that serves as input for the subsequent transformer. In particular, a vector representation of the input data can be provided. Furthermore, the patch processing unit retains the positional information of the sub-images.

The image or sub-image is thus converted into a numerical representation. These patches are then considered a sequence of tokens, similar to words in a sentence in natural language processing. Typically, the patches or sub-images overlap to better capture a local and global relationship of image features.

Furthermore, the image transformer network usually includes multiple transformer blocks. These include so-called attention mechanisms, for example, self-attention, attention matrices, or mechanisms for modeling the relationship of tokens or patches with each other. These transformer blocks process the patch sequences to extract global and local features in the image and model relationships between the patches.

In self-attention, also called self-attention, the relationships between each patch or token to other patches or tokens are captured and provided to the model.

For each patch or token, the attention mechanism calculates a weighting or attention distribution over all other tokens or patches in the image. This weighting indicates how relevant the other parts of the image are for the current token or patch.

Attention matrices show how each token or patch reacts to other tokens or patches. These attention matrices indicate which parts of the image are considered more important and which are considered less important.

By capturing these relationships between tokens in the form of self-attention and attention matrices, the model can absorb context information and capture relevant visual relationships within the image. This allows both global and local context information to be effectively processed.

The transformer blocks process the patch sequences to extract global and local features based on the above attention mechanisms and to model relationships between the patches. Furthermore, these attention mechanisms are combined with feedforward layers to update and improve the representation of the patches.

Furthermore, an image transformer network is usually designed to preserve the spatial positional information of the patch in the image, for example, by inserting positional encodings or other mechanisms, particularly in the patch embedding area, so that the statements provided by the image transformer network can be reproduced positionally correctly.

The advantage of such an image transformer network include its good scalability, allowing it to be applied to images of different sizes. The network does not require fixed input sizes as many CNN-based approaches do. The transformer mechanism allows the image transformer network to capture and utilize global context information across the entire image.

Furthermore, an image transformer network can be easily adapted to different tasks and adjusted for various tasks such as classification, object detection, image segmentation, and more.

This can be done, in particular, through a multi-layer perceptron downstream of the encoder included in the image transformer network.

In particular, an image transformer network can be trained in two phases. First, pretraining can be done based on a large dataset to learn the task of semantic segmentation. Furthermore, fine-tuning of the image transformer network can be done, for example, through training with application-specific data by the user of the image transformer network.

The image transformer network also allows parallel processing of data, which reduces the resources needed in inference.

In particular, a SegFormer network designed as an image transformer network can be provided for the semantic segmentation of the cross-sectional images of the crimp connection. However, other transformer architectures for semantic segmentation, such as the Detection Transformer (DETR), Vision and Language Bidirectional Encoder Representations from Transformers (VilBERT), and others, can also be used.

The training of an image transformer network, particularly a SegFormer network, can be done analogously to the procedure described above for training a CNN.

In an exemplary embodiment, the SegFormer architecture can be chosen as follows to achieve robust and reliable results in terms of image processing. However, the following described architecture is merely one possible design, and the skilled person is not limited to it.

The SegFormer network as an image transformer network includes an encoder side and a decoder side as a transformer network.

On the encoder side, for example, four transformer blocks connected in series can be provided, with each transformer block being preceded by a unit for patch processing.

Each transformer block has an output through which data, particularly image data or representations of image data processed in the respective transformer block, is provided. The first transformer block of the connected transformer blocks processes the image in relatively few patches, i.e., the original image is divided into relatively few patches, typically overlapping, for example, four patches (2×2).

Each patch is processed within the transformer block according to the above attention mechanisms and fed to a feedforward network. In a further step, new image data is then composed from these, for example, using overlap patch merging and provided at the output of the first transformer block.

These output image data of the first transformer block are then provided to the subsequent patch processing unit, which then provides the following second transformer block of the connected transformer blocks with a higher number of typically overlapping patches, for example, 16 patches (4×4). These are then processed in the second transformer block and provided at the output of the second transformer block.

The image data at the output of the second transformer block of the connected four transformer blocks are then provided to the subsequent patch processing unit, which then provides the following third transformer block, for example, 64 patches (8×8), typically overlapping. These are processed in the third transformer block and provided at the output of the third transformer block.

The image data at the output of the third transformer block of the connected four transformer blocks are then provided to the subsequent patch processing unit, which then provides the following fourth transformer block, for example, 256 patches (16×16), typically overlapping, processed in the fourth transformer block and provided at the output of the fourth transformer block.

The image data at the output of the fourth transformer block is then provided to a subsequent patch processing unit and then fed to a multi-layer perceptron, abbreviated MLP. Furthermore, all output data from each transformer block, i.e., exemplarily all four transformer blocks, is fed to the multi-layer perceptron.

A multi-layer perceptron (MLP) refers to a specific type of network layer used in the SegFormer architecture. A multi-layer perceptron is a simple form of a neural network consisting of at least three layers, typically more than three layers in usual applications.

There is an input layer, which receives data, for example, from the transformer blocks. This layer represents the input features and transfers them to the next layer, which is at least one hidden layer.

Typically, there are multiple hidden layers, but at least one hidden layer is downstream of the input layer. This at least one hidden layer is called “hidden” because it lies between the input and output layers and is not directly visible from the outside. In a multi-layer perceptron, multiple hidden layers can be present, especially a plurality of hidden layers. The data fed to the at least one hidden layer is processed in the desired manner using the weights created through training.

Furthermore, there is an output layer of the multi-layer perceptron, in which the processed data is output and typically further processed in the decoder area.

The decoder area of the SegFormer network typically has the task of scaling the determined relationships using the previous blocks and modules to the original image size, also called upsampling, to obtain as pixel-accurate segmentation results as possible.

The decoder area includes upsampling layers and corresponding transformations. For upsampling, bilinear upsampling can be used, for example, to scale the results to the desired size. This creates a smooth upscale of the predictions.

The decoder integrates the upscaling with local and global information captured in the encoder area by the transformer blocks. In this example, skip connections are also used to include detailed features from earlier layers in the processing by the multi-layer perceptron and the decoding process. The decoder can also include attention mechanisms applied to the data to be processed.

The output of the decoder of the image transformer network is the reconstructed segmentation masks representing the predicted class or category for each pixel in the image.

The decoder can be implemented variably, just like the encoder. Examples of the decoder implementation can be taken from the relevant platforms, such as huggingface.co or github.

However, the decoder's function is typically aimed at bringing the upscaled results or predictions to the original image size and providing detailed pixel-accurate segmentation results.

In another embodiment, the deep neural network is designed as an image transformer network, including a publicly available pretrained image transformer network and at least one network layer, particularly an additional network layer subsequently added by the user, specifically trained, especially subsequently, with application-specific training data for the image processing of a cross-sectional image of a crimp connection.

Application-specific training data are understood to be data provided from the specific application for which the image transformer network is to be used, here specifically, for example, the application segmentation and/or evaluation of cross-sectional images for crimp connections. Suitable pretrained image transformer networks for semantic segmentation are available, for example, via huggingface.co or github.

Pretrained image transformer networks have the advantage that they are easily adaptable and only require a small additional training effort to customize them for a specific task or application. It is therefore possible to use publicly available pretrained image transformer networks and adapt them with little effort to the specific application subsequently by the user.

The subsequent adaptation of the pretrained model to the specific application can be done by adding at least one new layer or modifying at least one existing layer of the model through appropriate training. Training with the application-specific data then leads to a corresponding adaptation of the model based on the training data, resulting in improved outcomes.

On the one hand, a simple adaptation of pretrained image transformer networks concerning the specific application of cross-sectional images of crimp connections can be generally done.

Furthermore, the nature of a crimp connection can vary from crimping device to crimping device. Therefore, application-specific data may be specific to the crimping device or crimping tool. This means that due to the low training effort, separate training of the image transformer network can be done for each crimping device or each crimping tool, providing an even further improved result in terms of image processing and subsequent image evaluation.

In another embodiment of the image processing device, the trained deep neural network is designed to generate a raster image with at least three classes from the received image, with a first class corresponding to an inner component of the crimp connection, particularly a conductor element, a second class corresponding to an outer component of the crimp connection, particularly a crimp sleeve, and a third class corresponding to the environment of the crimp connection.

It has been shown that it is already sufficient for robust and reliable image processing to provide three classes. However, additional classes can also be provided within the scope of image segmentation.

The first class, corresponding to an inner component of the crimp connection, does not necessarily have to be designed as a conductor element, for example, in the form of wires or a solid inner conductor, but can also be a more complex configuration. For example, this can be in the case of a jacket crimp, the cable configuration enclosed by the crimp sleeve, including the cable jacket.

The second of at least three classes can correspond to the outer component of the crimp connection. In particular, this class can be selected to correspond to the crimp sleeve of the crimp connection. This can particularly be a crimp sleeve for a jacket crimp or for an inner conductor crimp.

The third of at least three classes can correspond to the environment of the crimp connection. The environment is not part of the crimp connection. The environment can be air or other mechanical components, such as components that guide the crimp connection during image capture or other structures of a cable that are not to be considered for the analysis.

By providing such three classes within the scope of image processing, subsequent image evaluation can already be significantly improved. In particular, by accurately classifying the inner component of the crimp connection, the crimp sleeve, and its delimitation to the environment, a robust, reliable, and accurate basis for subsequent evaluation can be provided.

The at least three classes can be assigned corresponding different values. These can, in particular, be any distinguishable value ranges, with one value range being assigned to each class. The respective value range can also be a single value for a class. The assignment of a pixel to a corresponding value can be probability-based. A pixel is assigned the value that describes it with the greatest probability.

In one embodiment of the image processing device, the trained deep neural network is designed to assign a color to each of the first, second, and third classes, with adjacent classes being displayable as, particularly contrasting, color areas of different colors in the raster image and/or vector contour, and this color assignment is included in the output signal.

This embodiment is a suitable basis for a manual evaluator as well as for conventional image evaluation software to determine at least one qualitative and/or quantitative quality parameter of the crimp connection.

By means of the different color design of at least the first, second, and third classes, the contours and extents of the respective areas of the crimp connection, i.e., for example, the inner component, the outer component, and the environment of the crimp connection, can be quickly and clearly captured by a manual evaluator and/or image evaluation software, significantly increasing the reliability of an evaluation.

This is particularly simple if adjacent classes have colors that provide a sufficiently good contrast, making them easily distinguishable for the image evaluation software and/or the manual evaluator.

In particular, this allows the boundary contours of adjacent color areas, i.e., the boundary line between the first class and the second class or between the second and third class, to be well recognized.

In particular, exactly three classes can be provided, including the first, second, and third classes.

The output signal can be designed in such a way that the cross-sectional image of the crimp connection can be displayed as a three-color image with different colors. This is a particularly simple and clear representation of the cross-sectional image of the crimp connection to reliably assess its quality parameters manually or with the help of image evaluation software.

In another embodiment, the trained deep neural network is designed to determine the boundary contour between the first class and the second class and/or between the second and the third class. The boundary contour can be designed, in particular, as a line segment with a predetermined thickness, which includes or represents the boundary area of adjacent classes or colors. The trained deep neural network can also be designed to generate an output signal with which the determined boundary contour can be graphically displayed.

For example, at least one boundary contour can be approximated as a polygonal line during the evaluation using classical image algorithms, and qualitative and/or quantitative quality parameters of the crimp connection can be determined based on this.

Training such a network to determine boundary contours can be done, for example, using cross-sectional images of crimp connections, in which corresponding boundary contours have been manually added. The training data can be augmented and varied in the usual way, particularly as described above, to improve the network training.

The image processing device can be designed, in particular, to identify at least one point of the boundary contour based on which the determination of an especially quantitative quality parameter is to be carried out, for example, for determining at least one of the following quality parameters: crimp height, crimp width, measurable crimp width, support angle, support height, flank end distance, crimp flank end distance, burr height, burr width, bottom thickness, cavities between wires, cracks.

Such points are referred to as marker points because they mark the reference points for a possibly subsequent measurement of quality parameters. Marker points can also be provided that particularly mark defective structures in the cross-sectional image of the crimp connection, such as cavities between wires. If present, such cavities would be expected in the inner area of the crimp connection, corresponding to the first class.

These marker points can thus mark the points of the boundary contour necessary for determining the desired quality parameters and thus particularly for the quantitative evaluation of the cross-sectional image.

Marker points can be determined, for example, using simple logic operations, classical image evaluation algorithms, or a deep neural network trained for this purpose.

The boundary contour, particularly the line segment representing the boundary contour, can preferably be superimposed on the received cross-sectional image of the crimp connection. This creates a possibility for plausibility checking, as the boundary contour is visibly displayed in the received cross-sectional image of the crimp connection. Based on the boundary contour, a corresponding determination of quantitative and qualitative quality parameters of the crimp connection can be made. In particular, the relevant marker points for the respective quality parameters of the crimp connection can also be displayed.

In another embodiment of the image processing device, the output signal is designed to include a superimposed display based on the received image and the vector contour, particularly at least one boundary contour, with the measurement points used for determining the respective quality parameter being included as separately visible marker points in the superimposed display. This makes it particularly easy to conduct an evaluation based on this display. In particular, the marker points can be distinguishably designed, for example, in different colors, so that they can be directly assigned to a specific, particularly quantitative quality parameter. This facilitates a reliable and error-free evaluation. Marker points can be determined using corresponding logic operations based on the vector contour.

The disclosure also particularly includes an image evaluation device for the qualitative and/or quantitative assessment of the quality of a crimp connection. This includes an image processing device according to one of claims 1 to 6, with an error classification being performable based on the generated vector contour to determine predetermined qualitative and/or quantitative quality parameters of the crimp connection, and the image evaluation device being designed to generate and output an evaluation output signal depending on the performed error classification, particularly including the performed error classification for determining predetermined qualitative and/or quantitative quality parameters of the crimp connection.

The image evaluation device thus serves not only for image processing but also for image evaluation of the cross-sectional image of the crimp connection. This allows a reliable, objective, and robust determination of the qualitative and/or quantitative quality parameters of the crimp connection, as a manual evaluation can be omitted.

The error classification for determining predetermined qualitative and/or quantitative quality parameters of the crimp connection can be performed using classical image evaluation software not based on neural networks or in another manner. In particular, this can be done using a separate evaluation unit, to which the output signal of the image processing device can be supplied.

The term error classification is to be broadly understood in the context of the disclosure. The error classification thus concerns not only the presence of errors in a cross-sectional representation of the crimp connection but also the absence of errors. The error classification can be qualitative in nature, for example, crimp connection “acceptable” or crimp connection “not acceptable”. The error classification can also be designed to qualitatively and/or quantitatively classify different error images. Here, a quantitative determination is also understood as classification. The error classification thus particularly includes the categorization of qualitative and quantitative quality parameters of the crimp connection represented as a grinding image and the measurement of quantitative quality parameters, for example, in the form of actual values from the vector contour.

An actual value can be assigned to a quantitative quality parameter within the scope of image evaluation, understood as a measurement value for the respective quality parameter. This can be compared with a predetermined target value for the respective quality parameter.

To determine the actual values, the image evaluation device may be provided with a reference scale in addition to the cross-sectional image of the crimp connection, allowing the conversion of image features, for example, into SI units or other suitable scales, such as test stand-specific conversion values like pixels to millimeters. This allows easy comparison with possible target values, which can be specified in SI units, for example.

In an embodiment, the image evaluation device includes a trained deep neural network, with which the error classification for determining predetermined qualitative and/or quantitative quality parameters of the crimp connection can be performed.

Using a trained deep neural network, the error classification can be performed efficiently and reliably. The image evaluation device can especially include a separate trained deep neural network, designed to conduct the evaluation based on the output signal of the image processing device. Thus, the image evaluation device can include two separate deep neural networks connected in series, with a first trained deep neural network designed to perform image processing and a second trained deep neural network designed to conduct image evaluation based on the output signal of the image processing.

The deep neural network is trained in the manner described above for the corresponding classification task using training data that reflect the corresponding error classifications. The error classification for determining predetermined qualitative and/or quantitative quality parameters of the crimp connection can be performed, in particular, using a trained image transformer network or a trained deep convolutional network.

In another embodiment, the image evaluation device is designed so that the image processing and error classification for determining predetermined qualitative and/or quantitative quality parameters of the crimp connection can be performed using a common deep neural network. The image processing and image evaluation can thus be combined. The image processing as a basis for the evaluation of the grinding image of the crimp connection is directly linked to the image evaluation.

This has the advantage that only one training process for image processing and subsequent error classification is required, while at the same time providing a robust, reliable, and objective evaluation of the quality parameters of the crimp connection.

If a pretrained image transformer network is used for semantic segmentation, this can be easily extended concerning error classification and determining actual values for quantitative quality parameters.

In another embodiment, the evaluation output signal includes at least one quality parameter from the following group: defect-free crimp connection, crimp height, crimp width, measurable crimp width, support angle, support height, flank end distance, crimp flank end distance, burr height, burr width, bottom thickness, cavities between wires. In particular, the evaluation output signal can include at least one measurement value or actual values for at least one of the aforementioned quality parameters.

The basis for this is an error classification for at least one of the error classes from the following group: defect-free crimp connection, crimp height, crimp width, measurable crimp width, support angle, support height, flank end distance, crimp flank end distance, burr height, burr width, bottom thickness, cavities between wires. Using such preferably all quality parameters, the respective crimp connection can be comprehensively characterized.

The following quality parameters can be determined quantitatively and qualitatively: crimp height, crimp width, measurable crimp width, support angle, support height, flank end distance, crimp flank end distance, burr height, burr width, bottom thickness, cavities between wires.

In another embodiment of the image evaluation device, the evaluation output signal is designed to include a superimposed display based on the received image and the vector contour, particularly at least one boundary contour, with the measurement points used for determining the respective quality parameter being included as separately marked, particularly separately visible, marker points in the superimposed display.

Marker points are understood to be markings in the image that mark specific points in the image assigned to the respective quality parameter. In particular, using these markings placed, for example, on the edge of a boundary contour, distances, for example, in pixels, can be calculated. These distances can be converted into length units using a conversion scale.

In the embodiments relating to marker points as reference points for determining actual values for the crimp connection, it is not necessary for the marker points to be perceptible to a user. It is generally sufficient for determining actual values of quality parameters of the crimp connection if these are present and can be used for determining actual values.

However, it is advantageous if the marker points are separately marked so that a viewer of the superimposed display can quickly and easily identify the position of the marker points. This allows for a quick, possibly spot-check, review of the automated evaluation by monitoring personnel. This can be done particularly concerning whether the image evaluation device is working error-free.

In particular, different marker points can be used for different quality parameters, distinguishable from each other. In particular, the trained deep neural network can be designed to locate and mark the relevant marker points in the image. Furthermore, the trained deep neural network can be designed to generate an output signal with which the relevant marker points can be displayed in the image.

Different marker points can be used for one or more of the following quality parameters: defect-free crimp connection, crimp height, crimp width, measurable crimp width, support angle, support height, flank end distance, crimp flank end distance, burr height, burr width, bottom thickness, cavities between wires, and cracks. This way, each marker point can be easily assigned as a reference point for a related measurement.

In another embodiment, the image evaluation device is designed to provide the evaluation output signal to a central database, particularly a manufacturing database. This can be done, in particular, using a data interface included in the image evaluation device.

This allows the determined quality parameters to be stored or archived, and traceably documented. This makes the results of the image evaluation automatically assignable, documentable, retrievable, and traceable to the respective manufactured crimp connections. By eliminating manual recording of qualitative and/or quantitative quality parameters of the crimp connection, the consistency of the stored data can be ensured, contributing to improved data evaluation and management.

Furthermore, the image evaluation device can include an evaluation unit in which the quantitatively determined quality parameters are compared with target values for the manufactured crimp connection. Depending on the result of the comparison, a control signal can be generated, influencing the usability of similar crimp connections and/or affecting the production of further similar crimp connections.

The target values can be provided to the image evaluation device, particularly an evaluation unit of the image evaluation device, using a central database, particularly a manufacturing database, which is data-technically connected to the image evaluation device.

In the connectable central database, particularly the manufacturing database, the respective target values for the respective production orders of the crimp connections can be stored. These target values, in case of a connection to the image evaluation device, can be transmitted or requested, or received by the image evaluation device for comparison with the determined actual values, depending on the respective production order of the image evaluation device.

The disclosure also relates to a manufacturing release system for a crimping device with an image evaluation device according to one of claims 7 to 12, with a data interface to a database in which production order-dependent target values for crimp connections are stored, with a release unit designed to provide a release or a refusal of release for manufacturing the classified crimp connection after a comparison between at least one qualitative and/or quantitative quality parameter of the crimp connection with a corresponding target value.

The comparison thus takes place based on the evaluation output signal provided by the image evaluation device, which includes at least one qualitative and/or quantitative quality parameter. Depending on this comparison, the production is released or refused.

In another embodiment, the manufacturing release system includes a release unit designed to provide a release or refusal of release for the delivery of the classified crimp connection based on the evaluation output signal.

The release unit is thus designed not only to release manufacturing but also to release the delivery of crimp connections. This can be necessary if a manufacturing defect is only detected later, for example, through corresponding samples. In particular, a delivery stop can be noted in the central database so that the delivery of the defective crimp connection to the customer is prevented.

In another embodiment, the manufacturing release system includes a database, with the evaluation output signal including at least one quality parameter from the following group: defect-free crimp connection, crimp height, crimp width, measurable crimp width, support angle, support height, flank end distance, crimp flank end distance, burr height, burr width, bottom thickness, cavities between wires, cracks, is storable.

The image processing device, the receiving unit, the processing unit, the image evaluation device, the image evaluation unit, the comparison unit, the database, the release unit or any other unit described herein, may comprise or may be provided in or as part of at least one of a dedicated processing element e.g., a processing unit, a microcontroller, a field programmable gate array, FPGA, a complex programmable logic device, CPLD, an application specific integrated circuit, ASIC, or the like. A respective program or configuration may be provided to implement the required functionality. The image processing device, the receiving unit, the processing unit, the image evaluation device, the image evaluation unit, the comparison unit, the database, the release unit or any other unit described herein may at least in part also be provided as a non-transitory computer program product comprising computer readable instructions that may be executed by a processing element. In a further embodiment, the image processing device, the receiving unit, the processing unit, the image evaluation device, the image evaluation unit, the comparison unit, the database, the release unit or any other unit described herein may be provided as addition or additional function or method to the firmware or operating system of a processing element that is already present in the respective application as respective computer readable instructions. Such computer readable instructions may be stored in a memory that is coupled to or integrated into the processing element. The processing element may load the computer readable instructions from the memory and execute them.

In addition, it is understood, that any required supporting or additional hardware may be provided like e.g., a power supply circuitry and clock generation circuitry.

Generally, any computer program or computer program product disclosed herein is to be understood as a non-transitory computer program product.

### BRIEF DESCRIPTION OF FIGURES

The following embodiments of the disclosure are explained with reference to the accompanying figures. The figures show:

FIG. 1: a schematic representation of an embodiment of an image processing device.

FIG. 2: a schematic representation of the structure of an exemplary image transformer network configured as SegFormer.

FIG. 3: a schematic representation of a received image of a semantically segmented 3-color raster image and an overlaid image of the received image and determined boundary contours, in particular, producible by means of an image processing device according to FIG. 1.

FIG. 4: a schematic representation of a first embodiment of an image evaluation device.

FIG. 5: a schematic representation of a second embodiment of an image evaluation device.

FIG. 6: a schematic representation of a received image of a semantically segmented 3-color raster image, an overlaid image of an overlaid image of a received image and determined boundary contour, and quantitative quality parameters producible by means of an image evaluation device according to FIG. 4 or FIG. 5.

FIG. 7: a schematic embodiment of a manufacturing release device.

FIG. 8: a schematic cross-sectional view of a crimp connection.

The figures are merely schematic representations and serve only to explain the disclosure. Identical or equivalent elements are consistently designated with the same reference numerals.

### DETAILED DESCRIPTION

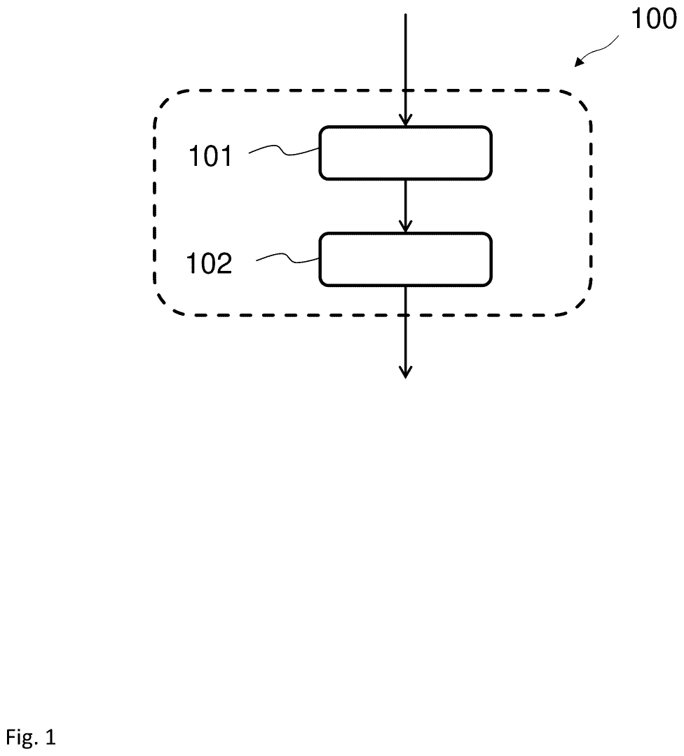

FIG. 1 shows a schematic representation of an image processing device 100. This includes a receiving unit 101 for receiving a recorded cross-sectional image of a crimp connection.

This may, in particular, be a digitally recorded cross-sectional image of the crimp connection, particularly a photographic microscopic image of the cross-section of the crimp connection. The plane of the cross-sectional image of the crimp connection is particularly perpendicular to a longitudinal central axis of a cable on which the crimp connection is arranged. However, another cross-sectional plane may be chosen if this appears helpful for determining quality parameters of the crimp connection.

Such a cross-sectional image of the crimp connection is typically generated by cutting the crimp connection perpendicular to the longitudinal axis of the cable. The cross-sectional image is usually prepared by grinding. Therefore, such a cross-sectional image is also referred to as a grinding image of the crimp connection.

The image processing device 100 further comprises a processing unit 102. The processing unit 102 serves to process the received cross-sectional image. By processing the received image, improved evaluation of the image is enabled, as processing can eliminate undesirable deviations from an ideal cross-sectional image with optimal recording conditions that frequently occur in practice.

The processing unit 102 comprises, for this purpose, a trained deep neural network configured as an image transformer network. The image transformer network is trained to process the image in the desired manner.

The image transformer network is particularly configured as a SegFormer and is designed to generate a semantically segmented raster image from the received image. In this process, each pixel of an area of interest in the received image, particularly each pixel of the received image, can be assigned to a predetermined class. The assignment is made according to the training data in which the respective classes were defined by corresponding annotation.

It is advantageous to use a publicly available pre-trained image transformer network and to adapt it individually for the segmentation task of cross-sectional images of crimp connections in the form of fine-tuning, i.e., in the form of subsequent training adapted to the specific task. This significantly reduces the training effort for the user of the image transformer network. For this purpose, for example, a pre-trained SegFormer can be used, which is then further trained by the user of the pre-trained SegFormer network using appropriately annotated training data.

From the raster image generated by the SegFormer, a vector contour can be generated by the processing unit 102. This means that the generated raster image is converted into a vector contour. This increases the accuracy of subsequent evaluation of the processed image. Based on this, an output signal is then generated by the processing unit 102, on the basis of which subsequent improved evaluation can be carried out.

By means of such image processing, artifacts and inaccuracies can be eliminated, thereby avoiding disruption of the evaluation by such artifacts and inaccuracies.

The output signal is configured to include at least one qualitative and/or quantitative quality parameter assignable to the crimp connection, such that this parameter can be determined from the output signal. This at least one quality parameter can then be determined by conventional image evaluation software and/or manually.

In a first variant, the conversion of the generated raster images into a vector contour can be done conventionally, i.e., without the use of a neural network. This is possible, for example, using known image processing techniques and algorithms. A common method for this is the application of the “Canny Edge Detector” technique in combination with Hough transformations.

However, it is also possible not only to have the raster image generated by the image transformer network but also—after corresponding training—the vector contour itself and, if necessary, additionally the corresponding output signal. In this context, the image transformer network may further include a residual network for generating the vector contour from the raster image.

Thus, after receiving the cross-sectional image of the crimp connection, all processing steps can be carried out by a correspondingly trained deep neural network, particularly an image transformer network.

The raster view generated by the trained deep neural network usually includes image areas assigned to a specific class. In a simple form, this may be a first class corresponding to an inner area of the crimp connection, for example, the inner conductor area. Furthermore, a second class may be provided corresponding to the crimp sleeve, and a third class corresponding to the environment of the crimp connection.

Optionally, a fourth class may be provided corresponding to voids within the first class, i.e., in the area of the inner conductor. Optionally, at least one additional class may be provided corresponding to a specific sub-area of the inner component, for example, individual wires, or a specific sub-area of the outer component, for example, a burr of the crimp sleeve.

The corresponding classes are usually planar areas of the cross-sectional image of the crimp connection. The vector contour determined from the raster view can also be formed as a planar area of the cross-sectional image, representing the determined classes.

The vector contour can also only concern a part of the raster image, in particular, at least one boundary area of adjacent classes. This boundary area or these boundary areas are generally of significant importance for determining the quantitative and/or qualitative quality parameters of the crimp connection.

The output signal provided by the image processing device can be configured, in particular, to allow graphical representation of the planar and/or linear vector contour.

The graphical representation can also—especially when displaying at least one boundary contour—be displayed superimposed on the received cross-sectional image of the crimp connection.

Furthermore, marker points can be determined that mark significant structures of the cross-section of the crimp connection, for example, the reference points for the crimp width (average width) or the measurable crimp width (maximum crimp width), etc.

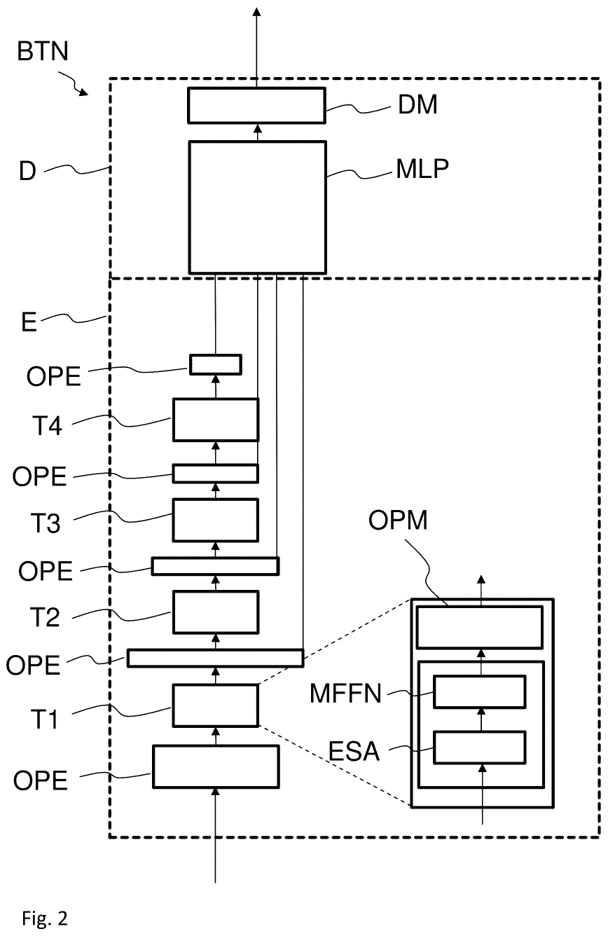

FIG. 2 shows a schematic representation of the structure of an image transformer network BTN configured as SegFormer. Such an image transformer network BTN comprises an encoder part E and a decoder part D. In general, of increased importance for the successful provision of a sufficiently good semantic segmentation of the cross-sectional image is, in particular, the encoder part E and the associated multi-layer perceptron MLP of the image transformer network BTN. The decoder part D serves, among other things, to scale the result of the encoder part E to the original image size, in particular, the number of pixels. However, the decoder part D may also have other or additional functionalities.

The encoder part E of the image transformer network is fed the cross-sectional image received by the receiving unit. This can be processed by means of overlap patch embedding OPE. In overlap patch embedding OPE, a plurality of sub-areas of the image can be provided in several overlapping patches. The overlap area can, for example, be 50%.

By overlapping, global and local context information is better captured, leading to an improved context representation regarding prediction or segmentation. Furthermore, the image or sub-images are converted into a machine-readable form for the transformer blocks. Overlap patch embedding OPE, in particular, helps to minimize artifacts that may occur due to the discrete nature of patch-based processing by supporting the continuity of features that extend over adjacent patches.

The overlapping patches of the received cross-sectional image of the crimp connection can be fed to a first transformer block T1, for example, in vector form. The structure of the image transformer network BTN shown here includes four transformer blocks T1, T2, T3, and T4, which are each structurally essentially identical and arranged in series. Furthermore, each transformer block is preceded by an overlap patch embedding OPE.

Each of the four transformer blocks T1, T2, T3, T4 includes so-called attention mechanisms, for example, self-attention, attention matrices, or mechanisms for modeling the relationships of the tokens or patches among themselves. These transformer blocks T1, T2, T3, T4 process the supplied patch sequences using these attention mechanisms to extract global and local features in the image and to model relationships between the patches.

For this purpose, the four transformer blocks T1, T2, T3, and T4 can each include a module for efficient self-attention ESA. This is a special form of self-attention, characterized by using alternative approaches to reduce the computational complexity of self-attention.

Approximate attention mechanisms and compressed representations are used to reduce the number of elements to be considered. The goal is to optimize the calculations for self-attention without significantly reducing the performance of the model.

Efficient self-attention ESA thus facilitates, on the one hand, the scalability of the SegFormer to large datasets and more complex tasks, which is why it can be easily adapted for further tasks. Moreover, the computational resource requirements are lower than with classical self-attention calculations.

After a patch has passed through the efficient self-attention ESA calculations, the generated is subsequently fed to a mix-feed-forward network MFFN, also referred to as mix-FFN. The mix-FFN MFFN performs mix operations based on the features of the individual patches. The goal of the mix-FFN MFFN is to improve the representations within each patch by combining or transforming various features or information.

The operations of the mix-FFN MFFN help to emphasize or enhance specific features that are relevant for the semantic segmentation of images by better highlighting or combining these features.

Subsequently, an overlap patch merging OPM occurs, where information from overlapping processed patches is merged or unified to achieve a more consistent and integrative representation of the image information. This allows for better integration of local and global context information.

Moreover, these overlaps help to reduce artifacts or discontinuities at the patch boundaries that could otherwise occur if the patch-based processing did not consider overlapping areas of the image. Overlap patch merging OPM further helps to reduce artifacts or discontinuities at the patch boundaries that could otherwise occur if the patch-based processing did not consider overlapping areas of the image.

Each transformer block T1, T2, T3, T4 has an output through which the data generated by the respective transformer block T1, T2, T3, T4 is provided. This data is then each fed to another overlap patch embedding OPE, which then, with a modified overlapping patch division, in particular, overlapping smaller patches, is fed in machine-readable form, for example, as a vector, to a subsequent transformer block, for example, T2. In this transformer block T2, the same structural steps as described above are performed. However, each transformer block T1, T2, T3, or T4 can also be differently structured.

In this way, the data of the received cross-sectional images successively pass through the four transformer blocks T1, T2, T3, and T4 with intermediate overlap patch embedding.

Not only the final result formed by all four transformer blocks T1, T2, T3, T4 is fed to a multi-layer perceptron MLP, but also all intermediate results. Therefore, there are so-called shortcuts, also called skip connections, which lead from the respective OPE steps to the multi-layer perceptron MLP and through which the corresponding data can be fed to the multi-layer perceptron MLP.

The multi-layer perceptron MLP complements the transformation functions of the transformer blocks T1, T2, T3, T4 by providing an additional level of feature modeling and processing specifically aimed at improving segmentation accuracy. It allows the model to tailor features specifically to the requirements of the segmentation task and to transform them in a targeted manner to achieve more precise segmentation.

The multi-layer perceptron MLP is, therefore, also the part of the model that can be adapted to the specific segmentation task here, the segmentation of cross-sectional images of a crimp connection, by adding a layer or modifying an existing layer through subsequent training, also referred to as fine-tuning.

The multi-layer perceptron MLP of the image transformer network BTN can be further developed through corresponding training to enable at least one error classification by means of the image transformer network. This means that further evaluation of the cross-sectional image of the crimp connection can be carried out beyond image processing.

The multi-layer perceptron MLP following the transformer blocks T1, T2, T3, T4 in the SegFormer is at least one additional layer applied to the output of the transformer blocks T1, T2, T3, T4 to improve segmentation results and further optimize model performance. This makes it possible to further refine and adapt the representations of the cross-sectional image of the crimp connection derived from the transformer blocks T1, T2, T3, T4.

The decoder D usually comprises a pixel class decoding layer that converts the extracted feature representations into pixel class predictions. For example, this involves assigning individual pixels to a class, such as the pixel belonging to the first class, second class, or third class. This layer is, therefore, of great importance for generating the desired raster view. This can be part of the multi-layer perceptron or configured separately.

Furthermore, on the decoder side D, upsampling operations and/or convolutional layers are usually present to increase the feature resolution and adjust the size of the predictions to the original input size of the image.

Typically, a classification layer is also present, which predicts the probabilities or labels for each pixel class in an image, leading to the creation of a complete semantic segmentation map or segmentation mask.

The decoding layer, the upsampling layer, and the classification layer are collectively represented as the decoder module DM in FIG. 2.

Such a pre-trained SegFormer network can be found, for example, at https://huggingface.co/docs/transformers/model_doc/segformer.

This model can then be adapted or customized for the specific application of semantic segmentation of cross-sectional images of crimp connections, possibly crimp connections manufactured on a specific crimping device.

By means of such a model, a semantically segmented raster image of the cross-sectional image of the crimp connection can be provided.

It is understood that a skilled person can also use other methods for performing semantic segmentation. In particular, a skilled person can also use a deep neural convolutional network trained for the respective task.

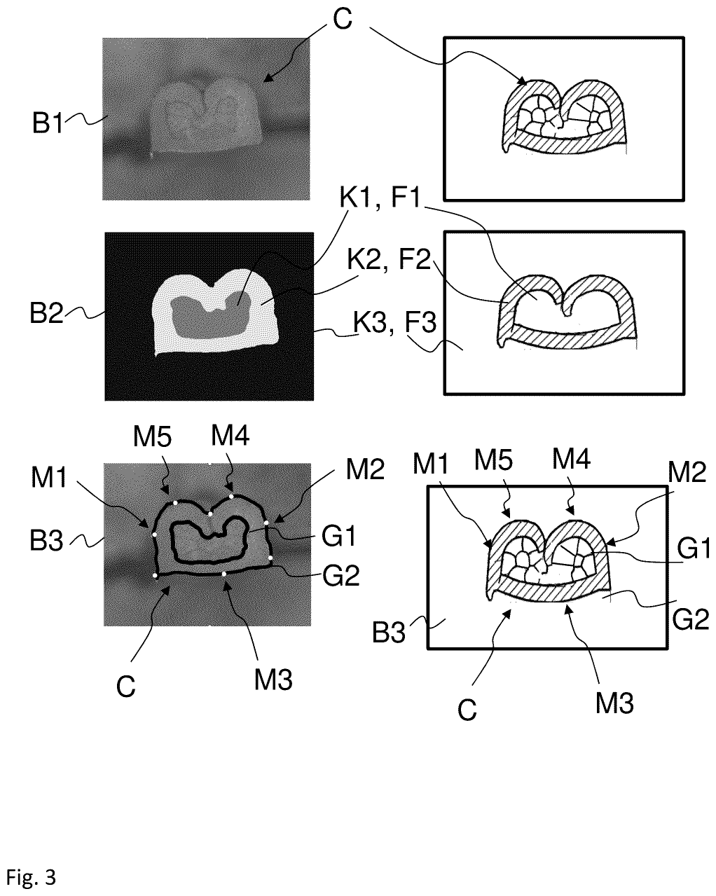

FIG. 3 shows three exemplary images of a cross-section of a crimp connection C, each in a view as a photograph and as a line drawing.

A first image B1 shows a representation of the received image, which is the subject of image processing by means of an image processing device, for example, the image processing device according to FIG. 1.

The second image B2 shows a semantically segmented raster image. The raster image includes a first class K1 corresponding to the inner conductor, a second class K2 corresponding to the crimp sleeve, and a third class K3 corresponding to the environment of the crimp connection. Each class K1, K2, K3 in the photograph is assigned a different color or shade. This makes the relative course of the boundary area between adjacent classes K1, K2, K3 clear.

The first class K1 has a first color F1, the second class K2 a second color F2, and the third class K3 a third color F3. Preferably, immediately adjacent color areas have a high contrast ratio, making them easily distinguishable visually.

The second image B2 has already been converted from a pixel-based raster view to a vector contour to increase the accuracy of a potential measurement on the second image B2.

The third image B3 shows the received image overlaid with a first boundary contour G1 and a second boundary contour G2. The first boundary contour G1 traces the boundary course of the first class K1 to the second class K2. This allows, for example, the inner conductor area to be distinguished from the crimp sleeve. The second boundary contour G2 traces the boundary course of the second class K2 to the third class K3, allowing, for example, the crimp sleeve to be distinguished from the environment of the crimp connection.

The boundary contours G1 and G2 may, for example, have been determined from the vector contour of the second image B2.

Furthermore, the third image B3 includes a plurality of marker points, in particular, marker points M1, M2, M3, M4, and M5, which can be used to determine quantitative quality parameters of the crimp connection. The marker points M1, M2, M3, M4, and M5 can be determined conventionally based on the vector contour, for example, through logic operations or by a correspondingly trained deep neural network.

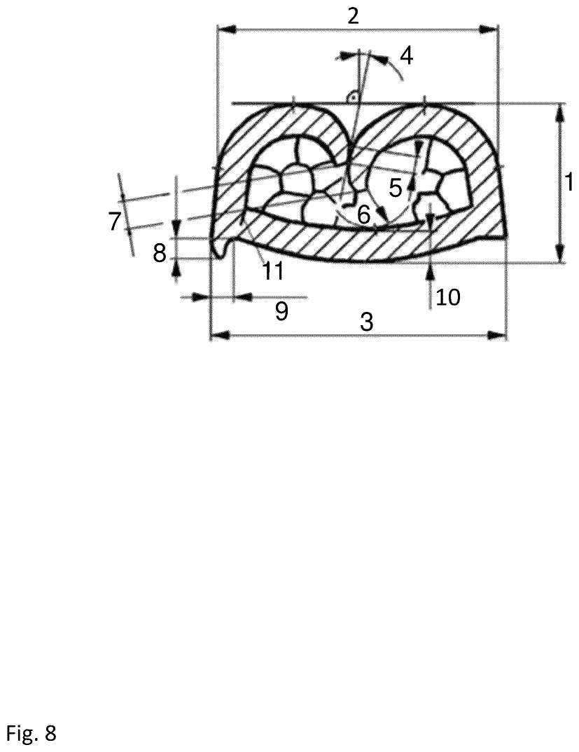

In image B3, exemplary marker points M1, M2, M3, M4, and M5 and additional marker points are each marked by a white dot. However, different colors or other distinguishing features can be provided for each marker point M1, M2, M3, M4, and M5. In particular, all reference points can be provided with marker points M1, M2, M3, M4, and M5, which are required for determining quantitative quality parameters; see in detail FIG. 8.

Based on the marker points M1 and M2, the (average) crimp width can be determined, for example. Using marker points M3, M4, and M5, the crimp height of the crimp connection can be determined, for example.

Based on the respective marker points, a traceable, objective measurement of quantitative quality parameters of the crimp connection C, recorded in cross-section, can be carried out.

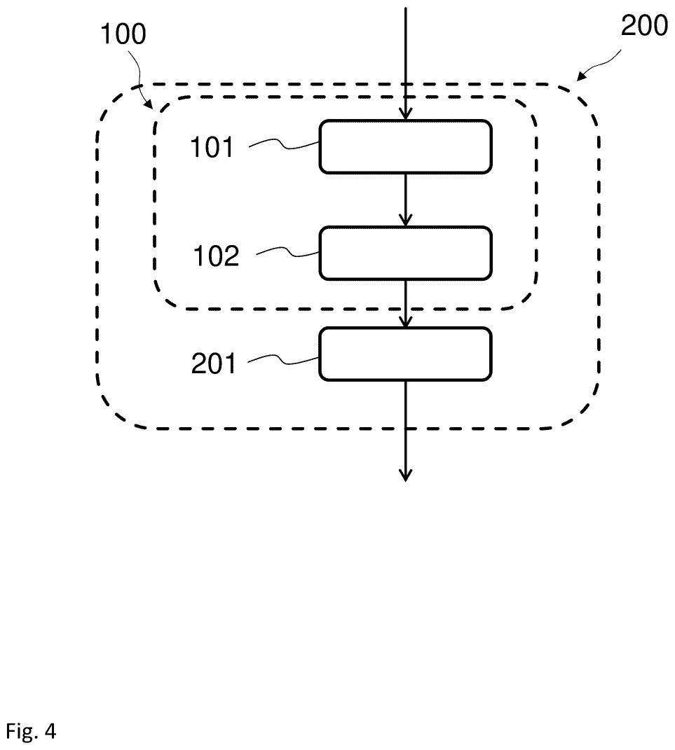

FIG. 4 shows an image evaluation device 200, which includes an image processing device 100 according to FIG. 1. The statements regarding the image processing device 100 in the context of FIG. 1 apply accordingly to FIG. 4.

The output signal provided by the image processing device 100 is evaluated by an evaluation unit 201 of the image evaluation device 200.

The evaluation unit 201 determines, for example, based on the provided marker points of the vector contour, the qualitative and/or quantitative quality parameters such as the absence of defects in the crimp connection, crimp height, crimp width, measurable crimp width, support angle, support height, flank end distance, crimp flank end distance, burr height, burr width, bottom thickness, voids between wires, and/or cracks. The evaluation unit 201 can also determine the marker points itself and not receive them from the image processing device.

In this process, the measurements for the respective quality parameters can first be determined from the vector contour for quantitative quality parameters. These can then be converted into real measurement units, such as degrees and length measurements, for example, in SI units, based on a corresponding scale.

In particular, this reference can be test stand-specific, thus accounting for the individual measurement setup for capturing the cross-sectional image of the crimp connection. The evaluation output signal can thus include quantitative quality parameters, for example, which can be evaluated in the context of a later comparison.

Furthermore, however, the evaluation unit can also be configured such that it provides an evaluation output signal that includes a statement about the presence or absence of defects concerning the analyzed crimp connection.

In particular, it can be determined based on qualitative quality parameters and/or by comparing the determined quantitative quality parameters of the crimp connection with corresponding target values, whether the crimp connection is “in order,” i.e. without errors, within the specified tolerances, or “not in order,” i.e., exceeding the specified tolerances.

In such a configuration, the evaluation unit 201 is advantageously designed to be able to access target values for specified quality parameters. In particular, an interface to a database (not shown in FIG. 4) can be provided, in which relevant manufacturing data, for example, target values for specific quantitative quality parameters, are stored and can be retrieved. These can then be used by the evaluation unit 201 for corresponding comparisons with determined actual values. Furthermore, the actual values determined by the image evaluation device 200 can be fed into the database and stored there for retrieval.

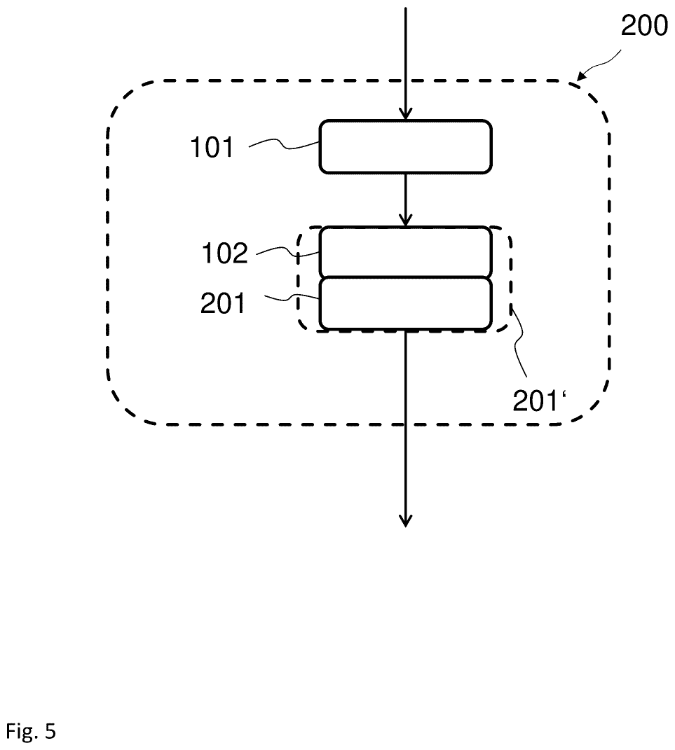

FIG. 5 shows another embodiment of an image evaluation device 200. This is characterized by the fact that the image processing unit 102 and the evaluation unit 201 are combined into a combined image analysis unit 201′.

The combined image analysis unit 201′ is designed such that it includes a trained deep neural network, particularly an image transformer network, which is designed to perform both image processing and evaluation.

For this purpose, the deep neural network is correspondingly trained, i.e., a raster image is generated by means of semantic segmentation of at least the relevant image area of the cross-sectional image, particularly the entire cross-sectional image of the crimp connection. Furthermore, the deep neural network is designed to generate at least one vector contour from the raster image and to carry out an error classification based on the generated vector contour to determine specified qualitative and/or quantitative quality parameters of the crimp connection.

Moreover, the trained deep neural network is designed to provide an evaluation output signal depending on the performed error classification, in particular, such that the evaluation output signal includes the performed error classification for determining specified qualitative and/or quantitative quality parameters of the crimp connection.

Such a trained deep neural network can have the structure shown in FIG. 2, with the multi-layer perceptron trained to fulfill the aforementioned tasks. Additional layers can be added to the multi-layer perceptron for this purpose, trained based on error-classified training data.

By means of an exemplary configuration of an image evaluation device 200 according to FIG. 4 or FIG. 5, a largely error-free automated determination of quantitative and/or qualitative quality parameters can be enabled, making the measurement of the properties of a crimp connection objective.

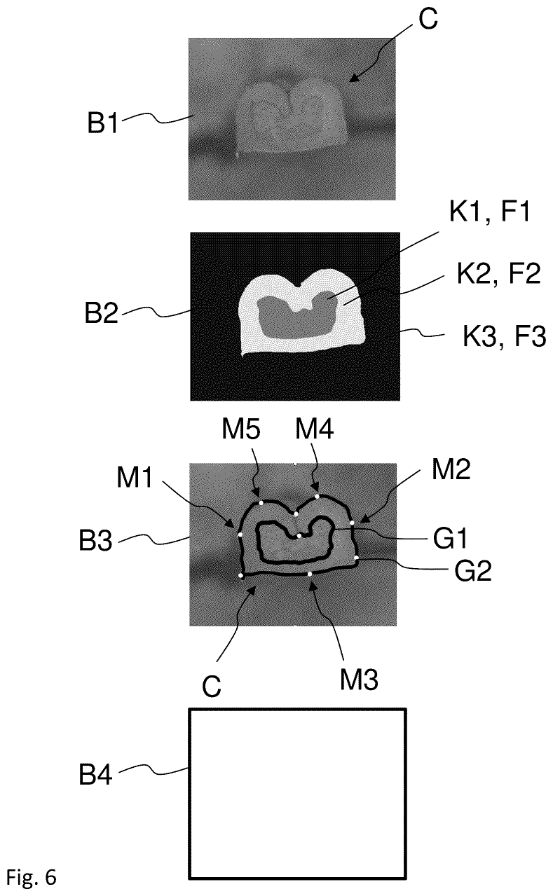

FIG. 6 shows a possible result of an image evaluation device 200. FIG. 6 includes, in this respect, the image representations B1, B2, and B3 generated by an image processing device, corresponding to FIG. 3.

Moreover, FIG. 6 includes a fourth image B4, which, for example, represents the actual values determined by the image transformer network for the examined crimp connection C and/or qualitative quality parameters such as “in order” or “not in order.”

In particular, the fourth image B4 may have the following content, for example.

| Grinding Image Dimension/Quantitative | Actual Value/ | |
|---|---|---|
| Quality Parameter | Quantity [cm] | Quality |
| Crimp Height | 0.6641 | In Order |
| Crimp Width | 1.0002 | In Order |
| Measurable Crimp Width | 1.0339 | Not in Order |
| Support Angle | 3.6285 | In Order |
| Support Height | 0.1742 | In Order |
| Bottom Thickness | 0.1164 | In Order |
| Void Between wires | vorhanden | Not in Order |
| Overall Result Crimp Connection | | Not in Order |

The actual values in the preceding table are determined by the trained deep neural network, which provides a corresponding evaluation output signal that includes the corresponding actual values or statements.

The evaluation can also include a comparison of whether determined actual values lie within a specified tolerance range around a target value for the respective quality parameter of the crimp connection. The comparative evaluation can be performed separately from the trained deep neural network, for example, by means of a separate comparison unit, or also by the trained deep neural network. This can be included in the image evaluation device.

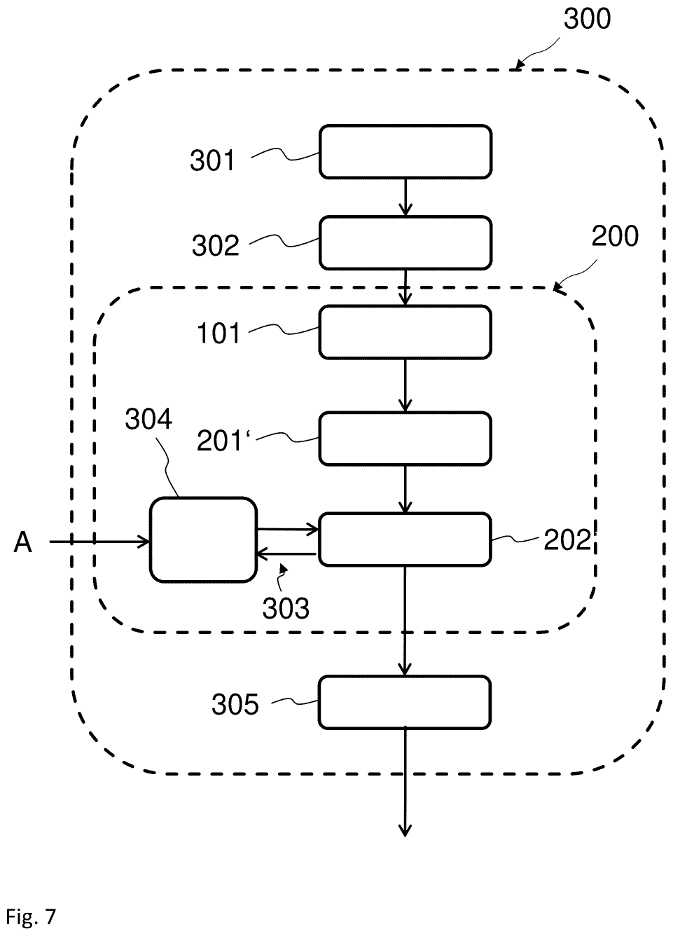

FIG. 7 shows a schematic representation of a manufacturing release system 300 for a crimping device for manufacturing a crimp connection.

The manufacturing release system 300 in this embodiment includes a cutting unit 301 in which a cross-section of a crimp connection can be generated by cutting and grinding the crimp connection perpendicular to the longitudinal direction of the cable comprising the crimp connection.

Furthermore, the manufacturing release system 300 includes an image capture device 302 configured as a microscope for capturing a digital image of the cross-section of the crimp connection. The cut crimp connection is thus fed to the microscope 302 and captured image-wise by the microscope 302, particularly as precisely as possible and without image capture errors.

Furthermore, the manufacturing release system 300 includes an image evaluation device 200. This can be configured, for example, according to FIG. 4 or FIG. 5. This includes a receiving unit 101 for receiving the cross-sectional image of the crimp connection.

Furthermore, this includes a trained deep neural network configured as an image transformer network, which is trained to perform both image processing and evaluation. This is made available by means of a combined image analysis unit 201′.

The combined image analysis unit 201′ is designed such that desired quantitative and qualitative quality parameters of the crimp connection can be determined by means of error classification. The quantitative quality parameters can, in particular, include: crimp height, crimp width, measurable crimp width, support angle, support height, flank end distance, crimp flank end distance, burr height, burr width, bottom thickness, voids between wires, cracks.

By means of the combined image analysis unit 201′, among other things, a quantitative determination of quality parameters of the crimp connection is carried out, i.e., a measurement of distances and/or angles based on the captured and processed cross-sectional image of the crimp connection.

In the context of determining the quantitative quality parameters, any used marker points for quantitative determination do not necessarily have to be visually displayable. However, visual availability of the used marker points serves better traceability of the determined measurement values.

The determined quantitative quality parameters are fed to a comparison unit 202, which is included in the image evaluation device 200 according to FIG. 7. This is, however, not mandatory. The comparison unit 202 is connected to a manufacturing database 304, also included in the manufacturing release system 300, via a database interface 303. The manufacturing database 304 can, for example, be configured as a database, e.g., as an ERP database, particularly as an SAP database.

The manufacturing database 304 includes relevant manufacturing data for a production order A, and thus corresponding target values for a crimp connection according to the production order A. Thus, the manufacturing database 304 can provide target values for the desired quantitative quality parameters and transmit them to the comparison unit 202.

The comparison unit 202 compares the determined quantitative quality parameters with the corresponding target values. Based on the comparison, it is apparent whether the manufactured and analyzed crimp connection is defective or not. Furthermore, the determined quantitative quality parameters, i.e., the corresponding actual values, are fed to the manufacturing database 304 and stored there.

By means of the comparison unit 202, a release unit 305 is connected. By means of the release unit 305, it can be determined whether the manufacturing of the crimp connection should be released or not.

If the comparison reveals that the crimp connection has quantitative quality parameters that are within the target value tolerances, the manufacturing of the crimp connection is released. If the comparison reveals that the crimp connection has quantitative quality parameters that are not within the target value tolerances, the manufacturing of the crimp connection is not released. This can also apply to qualitative, i.e., non-measured quality parameters, where a release is not granted by the release unit 305 if a specified quality parameter is qualitatively classified as “not in order.”

Furthermore, the release unit 305 can be connected to the delivery system. If a subsequent analysis of a cross-sectional image of a crimp connection leads to the conclusion that it is expected that a manufacturing order carried out is defective, the release unit 305 can be designed to provide a signal stopping the delivery of the manufacturing order to the customer.

It is understood that a skilled person can also divide the functionalities of the aforementioned units for the manufacturing release system 300 differently or provide them, if necessary, by means of a single technical unit.

FIG. 8 shows a schematic cross-sectional view of a crimp connection, indicating the reference points for measuring quantitative quality parameters.

Reference numeral 1 indicates the reference points of the crimp connection for measuring the crimp height; reference numeral 2 indicates the reference points of the crimp connection for measuring the crimp width. Reference numeral 3 indicates the reference points of the crimp connection for measuring the measurable crimp width. Reference numeral 4 indicates the reference points of the crimp connection for measuring the support angle. Reference numeral 5 indicates the reference points of the crimp connection for measuring the support height. Reference numeral 6 indicates the reference points of the crimp connection for measuring the flank end distance. Reference numeral 7 indicates the reference points of the crimp connection for measuring the crimp flank end distance. Reference numeral 8 indicates the reference points of the crimp connection for measuring the burr height. Reference numeral 9 indicates the reference points of the crimp connection for measuring the burr width. Reference numeral 10 indicates the reference points of the crimp connection for measuring the bottom thickness. Reference numeral 11 indicates the reference points of the crimp connection for measuring a crack. Although not shown, it is easily possible for a skilled person, based on their expertise, to determine a corresponding measurement of the void, possibly in multiple directions, based on marker points for voids. This applies analogously to the determination of cracks.

Since the detailed devices and methods described above are exemplary embodiments, they can be modified by a skilled person to a wide extent without departing from the scope of the disclosure. In particular, the mechanical arrangements and the size relationships of the individual elements to one another are merely exemplary.

### REFERENCE LIST

100 Image Processing Device
101 Receiving Unit
102 Processing Unit
200 Image Evaluation Device
201 Image Evaluation Unit
201′ Combined Image Analysis Unit with a Trained Deep Neural Network for Image Processing and Evaluation
202 Comparison Unit
300 Manufacturing Release System
301 Cutting Unit
302 Image Capture Device
303 Database Interface
304 Database
305 Release Unit
K1 First Class: Inner Component of the Crimp Connection: Conductor Element
K2 Second Class: Outer Component of the Crimp Connection: Crimp Sleeve
K3 Third Class: Environment of the Crimp Connection
B1 Received Cross-Sectional Image
B2 Raster Image in 3 Colors
B3 Overlaid Image of Received Image and Boundary Contour
F1 Color 1
F2 Color 2
F3 Color 3
G1 Boundary Contour Between First and Second Class
G2 Boundary Contour Between Second and Third Class
C Cross-Section of the Crimp Connection
M1 Marker Point 1
M2 Marker Point 2
M3 Marker Point 3
M4 Marker Point 4
M5 Marker Point 5
A Order Number
T1 First Transformer Block
T2 Second Transformer Block
T3 Third Transformer Block
T4 Fourth Transformer Block
OPE Overlap Patch Embedding
MLP Multi-Layer Perceptron
ESA Efficient Self Attention
MFFN Mix-Feed Forward Network
OPM Overlap Patch Merging
E Encoder
D Decoder
DM Decoder Module
BTN Image Transformer Network
1 Crimp Height
2 Crimp Width
3 Measurable Crimp Width
4 Support Angle
5 Support Height
6 Flank End Distance
7 Crimp Flank End Distance
8 Burr Height
9 Burr Width
10 Bottom Thickness
11 Crack

1. An image processing device for supporting a qualitative or quantitative evaluation of the quality of a crimp connection, comprising:
a receiving unit for receiving a cross-sectional representation of an image of a crimp connection, configured as a digital microscope image in the visible spectral range; and
a processing unit designed to:
generate a raster image of the received image from the received image using a trained deep neural network, whereby at least the pixels of a relevant image area of the received image are assignable to a predetermined class using the trained deep neural network,
generate at least one vector contour from the generated raster image, and
generate and output an output signal based on the determined vector contour, from which the qualitative or quantitative quality parameter assignable to the crimp connection can be determined.

2. The image processing device according to claim 1, wherein the trained deep neural network includes an image transformer network or a convolutional network.

3. The image processing device according to claim 2, wherein the deep neural network is configured as an image transformer network, and the image transformer network includes a publicly available pre-trained image transformer network as well as at least one network layer, which is subsequently trained with application-specific training data for image processing.

4. The image processing device according to claim 1, wherein the trained deep neural network is designed to generate a raster image with at least three classes from the received image, wherein a first class corresponds to an inner component of the crimp connection that comprises a conductor element, a second class corresponds to an outer component of the crimp connection that comprises a crimp sleeve, and a third class corresponds to the environment of the crimp sleeve.

5. The image processing device according to claim 4, wherein the trained deep neural network is designed to assign at least the first, second, and third classes each a color, wherein adjacent classes can be represented in the raster image or in the vector contour as contrasting color areas of different colors, and this color assignment is included in the output signal.

6. The image processing device according to claim 4,
wherein the trained deep neural network is designed to determine a boundary contour between the first class and the second class or between the second class and the third class.

7. An image evaluation device for the qualitative or quantitative evaluation of the quality of a crimp connection, comprising:
an image processing device according to claim 1,
wherein, based on the generated vector contour, an error classification for determining specified qualitative or quantitative quality parameters of the crimp connection can be carried out,
wherein an evaluation output signal can be generated and output depending on the performed error classification, comprising the performed error classification for determining the specified qualitative or quantitative quality parameters of the crimp connection.

8. The image evaluation device according to claim 7, comprising a trained deep image transformer network (BTN), by which the error classification for determining the specified qualitative or quantitative quality parameters of the crimp connection can be carried out.

9. The image evaluation device according to claim 8, wherein the image processing and the error classification for determining the specified qualitative or quantitative quality parameters of the crimp connection can be carried out by a common image transformer network (BTN).

10. The image evaluation device according to claim 7, wherein the evaluation output signal includes at least one quality parameter from the following group: defect-free crimp connection, crimp height, crimp width, measurable crimp width, support angle, support height, flank end distance, crimp flank end distance, burr height, burr width, bottom thickness, voids between wires, or cracks.

11. The image evaluation device according to claim 7, wherein the evaluation output signal is designed to include an overlaid representation based on the received image and the vector contour, wherein the used measurement points for determining the respective quality parameter are included as specially marked marker points in the overlaid representation.

12. The image evaluation device according to claim 7, which is designed to feed the evaluation output signal to a manufacturing database.

13. A manufacturing release system for a crimping device, comprising:
an image evaluation device according to claim 7;
a data interface to a database in which production order-dependent target values for crimp connections are stored; and
a release unit designed to provide a release or a refusal of release for manufacturing the error classified crimp connection after a comparison between at least one qualitative or quantitative quality parameter of the specified qualitative or quantitative quality parameters and a corresponding target value.

14. The manufacturing release system according to claim 13, further comprising:
a release unit which is designed to provide a release or a refusal of release of a delivery of the classified crimp connection based on the evaluation output signal.

15. The manufacturing release system according to claim 13, further comprising:
a database where the output signal including at least one parameter from the following group: defect-free crimp connection, crimp height, crimp width, measurable crimp width, support angle, support height, flank end distance, crimp flank end distance, burr height, burr width, bottom thickness, voids between wires, or cracks can be stored.
